(19) United States
(12) Patent Application Publication
(10) Pub. No.: US 2012/0127715 A1
(43) Pub. Date: May 24, 2012

(54) LASER MODULE

(75) Inventors: Maiko Ariga, Tokyo (JP); Toshio Sugaya, Tokyo (JP); Toshio Kimura, Tokyo (JP)

(73) Assignee: FURUKAWA ELECTRIC CO., LTD., TOKYO (JP)

(21) Appl. No.: 13/388,666

(22) PCT Filed: May 6, 2011
(86) PCT No.: PCT/JP11/02555

§ 371 Date: Feb. 3, 2012

(30) Foreign Application Priority Data
May 7, 2010 (JP) 2010-107553

(51) Int. Cl. F21V 7/00; F21V 9/00

(52) U.S. Cl. 362/235; 362/304; 362/293

(57) ABSTRACT

[Objective] To prevent change in a direction of an optical axis of a split light within a plane parallel to a surface on which the beam splitter is installed.

[Means] A laser module including a laser light source that emits a laser light and a beam splitter that splits a portion of the laser light emitted from the laser light source. The beam splitter includes a first reflective surface and a second reflective surface that are parallel to each other. The first reflective surface transmits a first portion of the laser light and reflects a second portion of the laser light to the second reflective surface. The second reflective surface receives the second portion of the laser light from the first reflective surface and reflects received laser light in a direction parallel to the laser light emitted from the laser light source.

### TECHNICAL FIELD

The present invention relates to a laser module including a beam splitter that splits a laser light from a laser light source. The contents of the following Japanese patent application are incorporated herein by reference, No. 2010-107553 filed on May 7, 2010

### BACKGROUND ART

In the field of wavelength-division-multiplexing (WDM) communication, which involves multiplexing and simultaneously transmitting a plurality of optical signals with different wavelengths through a single optical fiber, increase in the amount of information being transmitted has created a desire for multiplexing optical signals with narrower wavelength intervals. In order to multiplex optical signals with narrower wavelength intervals, the wavelength of the laser light emitted from the laser light source must be controlled in a highly-accurate manner. Therefore, laser modules are being developed that use beam splitters to split portions of the laser lights emitted from laser light sources (see, for example, Patent Documents 1 and 2).

Patent Document 1: Japanese Patent Application Laid-open No. 2002-185074

Patent Document 2: Japanese Patent Application Laid-open No. 2004-246291

### DISCLOSURE OF THE INVENTION

A laser module uses a detector to detect the power and the wavelength of the laser light split by the beam splitter. The laser module controls the temperature of the laser light source, based on the detection results, to control the wavelength of the laser light emitted from the laser light source.

However, in a conventional laser module, the angle of the incident surface of the beam splitter with respect to the laser light changes within a plane parallel to a surface on which the beam splitter is installed. More specifically, when the beam splitter is fixed to the installation surface using YAG laser welding, soldering, or a resin adhesive, the movement that occurs during the installation causes the angle of the incident surface of the beam splitter to change within a plane parallel to the surface on which the beam splitter is installed.

When the angle of the incident surface of the beam splitter changes in a plane parallel to the surface on which the beam splitter is installed, the optical axis of the split light deviates from its direction intended by design. As a result, the split light is not incident on the detector arranged according to this intended direction, and therefore the power or wavelength of the split light cannot be detected. Even if the split light is incident on the detector, the wavelength of the laser light cannot be accurately detected if the detector includes an etalon filter, since the angle of incidence of the split light with respect to the etalon filter changes. Accordingly, a laser module is desired that can prevent change in the direction of the optical axis of the split light in a plane parallel to the surface on which the beam splitter is installed.

The present invention has been achieved in view of the above problems, and it is an object of the present invention to provide a laser module that can prevent change in the direction of the optical axis of the split light in a plane parallel to a surface on which the beam splitter is installed.

To solve the above problems and to achieve the object, according to one aspect of the present invention, there is provided a laser module including a laser light source that emits a laser light and a beam splitter that splits a portion of the laser light emitted from the laser light source. The beam splitter includes a first reflective surface and a second reflective surface that are parallel to each other. The first reflective surface transmits a first portion of the laser light and reflects a second portion of the laser light to the second reflective surface. The second reflective surface receives the second portion of the laser light from the first reflective surface and reflects received laser light in a direction parallel to the laser light emitted from the laser light source.

In the laser module, the second reflective surface transmits a first portion of the received laser light and reflects a second portion of the received laser light in the direction parallel to the laser light emitted from the laser light source. The laser module may further include a wavelength detector that receives the first portion of the laser light transmitted by the first reflective surface or the second portion of the laser light reflected by the second reflective surface and detects a wavelength of the laser light emitted from the laser light source.

The wavelength detector may include an etalon filter that selectively transmits a laser light of a predetermined wavelength, for example. The beam splitter has a rectangular parallelepiped shape formed by bonding a plurality of prisms, and the resulting bonding surfaces between the prisms function respectively as the first reflective surface and the second reflective surface. The prisms are bonded using a resin adhesive.

The laser light source is a distributed feedback semiconductor laser element. The laser light source may be a distributed Bragg reflector semiconductor laser element. The laser light source may be an array-type semiconductor laser element obtained by integrating a plurality of longitudinal single-mode semiconductor laser elements, a semiconductor optical amplifier that amplifies a laser light emitted from at least one of the longitudinal single-mode semiconductor laser elements, and a multiplexer that guides the laser lights emitted from the at least one of the longitudinal single-mode semiconductor laser elements to the semiconductor optical amplifier.

### EFFECT OF THE INVENTION

According to the laser module of the present invention, a split light can be split in a manner to always be parallel to the incident laser light, even when an angle of the incident surface of the beam splitter with respect to the laser light changes within a plane parallel to the surface on which the beam splitter is installed. Accordingly, the change in the direction of the optical axis of the split light in a plane parallel to the surface on which the beam splitter is installed can be prevented.

### BRIEF DESCRIPTION OF DRAWINGS

FIG. 1 is a schematic cross-sectional view of a laser module according to a first embodiment of the present invention as seen from above.

FIG. 2 is a schematic view of a laser light source shown in FIG. 1.

FIG. 3 is a schematic view of the structure of a beam splitter as seen from above.

FIGS. 4A and 4B schematically show change in the optical path of a split light and transmitted light resulting from a change in the angle of the incident surface of the beam splitter with respect to the installation surface.

FIG. 5 is a cross-sectional schematic view of a laser module according to a second embodiment of the present invention as seen from above.

### DETAILED DESCRIPTION

### First Embodiment

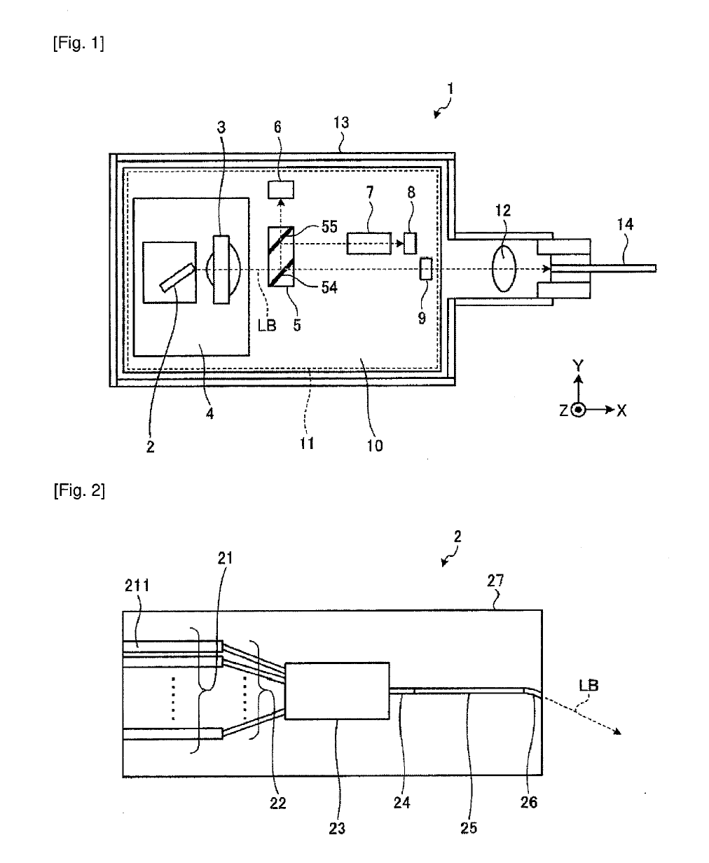

FIGS. 1 and 2 are used to describe the structure of a laser module 1 according to a first embodiment of the present invention.

FIG. 1 is a schematic cross-sectional view of the laser module 1 as seen from above. FIG. 2 is a schematic view of the structure of a laser light source 2 shown in FIG. 1. In this Specification, the direction in which the laser light is emitted in a horizontal plane defines the X-axis, the direction perpendicular to the X-axis in the horizontal plane defines the Y-axis, and the direction normal to the horizontal XY-plane, i.e. the vertical direction, defines the Z-axis.

As shown in FIG. 1, the laser module 1 includes the laser light source 2, a collimating lens 3, a Peltier device 4, a beam splitter 5, a power-monitoring photodiode 6, an etalon filter 7, a wavelength-monitoring photodiode 8, an optical isolator 9, a base plate 10, a Peltier device 11, a focusing lens 12, and a case 13 that houses all these components.

As shown in FIG. 2, the laser light source 2 includes a semiconductor laser array 21, waveguides 22, a multiplexer 23, a waveguide 24, a semiconductor optical amplifier (SOA) 25, and a curved waveguide 26. The laser light source 2 is an array-type semiconductor laser element formed by integrating the above components on a single substrate 27.

The semiconductor laser array 21 includes a plurality of longitudinal single-mode semiconductor laser elements (hereinafter “semiconductor laser elements”) 211, formed in a stripe to emit a laser light with different wavelengths from a front facet. The semiconductor laser elements 211 are distributed feedback (DFB) laser elements, and the oscillation wavelengths thereof can be controlled by adjusting the temperature of the elements.

More specifically, the oscillation wavelength of each semiconductor laser element 211 can be changed in a range from approximately 3 nanometers to 4 nanometers, for example. The semiconductor laser elements 211 are designed such that the oscillation wavelengths thereof have intervals of approximately 3 nanometers to 4 nanometers therebetween. Therefore, by switching the semiconductor laser elements 211 and controlling the temperatures of the semiconductor laser elements 211, the semiconductor laser array 21 can emit a laser light LB with a wavelength region that is continuous over a wider bandwidth than a single semiconductor laser element.

By integrating ten or more semiconductor laser elements 211 with oscillation wavelengths that can be changed in a range from 3 nanometers to 4 nanometers, the wavelength of the resulting laser light can be changed over a wavelength region of 30 nanometers or more. Accordingly, these ten or more semiconductor laser elements 211 can cover the entire wavelength region used for WDM communication, which can be a C-band from 1.53 micrometers to 1.56 micrometers or an L-band from 1.57 micrometers to 1.61 micrometers, for example.

A waveguide 22 is provided for each semiconductor laser element 211, and guides the laser light LB emitted from the corresponding semiconductor laser element 211 to the multiplexer 23. The multiplexer 23 may be a multi-mode interferometer (MMI) coupler, for example, and guides the laser lights LB from the waveguides 22 to the waveguide 24. The waveguide 24 guides the laser light LB from the multiplexer 23 to the semiconductor optical amplifier 25. The semiconductor optical amplifier 25 amplifies the laser light LB guided by the waveguide 24, and guides the amplified laser light LB to the curved waveguide 26.

The curved waveguide 26 emits the laser light LB guided by the semiconductor optical amplifier 25 in the X-axis direction at an angle of approximately 7 degrees with respect to the emitting facet. The angle that the laser light LB forms with respect to the emitting facet is preferably adjusted to be in a range from 6 degrees to 12 degrees. As a result, less light is reflected toward the semiconductor laser array 21.

The following describes the structure of the laser module 1 based on FIG. 1. The collimating lens 3 is arranged near the emitting facet of the laser light source 2. The collimating lens 3 collimates the laser light LB emitted from the laser light source 2, and guides the collimated laser light LB to the beam splitter 5. The Peltier device 4 has the laser light source 2 and the collimating lens 3 loaded on a horizontal installation surface thereof, which is in an XY-plane. The Peltier device 4 controls the oscillation wavelengths of the semiconductor laser elements 211 by adjusting the temperature of the laser light source 2 based on the amount of current input thereto.

The beam splitter 5 transmits a portion of the laser light LB from the collimating lens 3, and guides this portion to the optical isolator 9. The beam splitter 5 splits the other portion of the laser light LB from the collimating lens 3, i.e. the portion not transmitted by the beam splitter 5, toward the power-monitoring photodiode 6 and the etalon filter 7. The power-monitoring photodiode 6 detects the power of the laser light LB split by the beam splitter 5. The power-monitoring photodiode 6 inputs, to a control apparatus connected to the laser module 1, an electric signal corresponding to the detected power.

The etalon filter 7 has periodic transmission characteristics with respect to the wavelength of the laser light LB, and selectively transmits the laser light LB with a power corresponding to the transmission characteristics, to be input to the wavelength-monitoring photodiode 8. The wavelength-monitoring photodiode 8 detects the power of the laser light LB input from the etalon filter 7, and inputs an electric signal corresponding to the detected power to the control apparatus. The etalon filter 7 and the wavelength-monitoring photodiode 8 function as the wavelength detector of the present invention. The power of the laser light LB detected by the power-monitoring photodiode 6 and the wavelength-monitoring photodiode 8 is used by the control apparatus to perform wavelength locking control.

Specifically, the laser module 1 is controlled by the control apparatus to perform the wavelength locking control by controlling drive current of the semiconductor optical amplifier 25 such that a ratio between the power of the laser light LB detected by the power-monitoring photodiode 6 and the power of the laser light detected by the wavelength-monitoring photodiode 8 matches the ratio achieved when the oscillation wavelength and power of the laser light LB are desired values. Furthermore, the laser module 1 adjusts the temperature of the laser light source 2 as a result of the control apparatus controlling the Peltier device 4. With the structure described above, the laser module 1 can control the oscillation wavelength and power of the laser light LB to be the desired values.

The optical isolator 9 restricts returned light from the optical fiber 14 from being recombined with the laser light LB. The base plate 10 is provided with an installation surface parallel to the XY-plane. The laser light source 2, the collimating lens 3, the beam splitter 5, the power-monitoring photodiode 6, the etalon filter 7, the wavelength-monitoring photodiode 8, and the optical isolator 9 are loaded on the base plate 10. The Peltier device 11 controls the selected wavelength of the etalon filter 7 by adjusting the temperature of the etalon filter 7 via the base plate 10. The focusing lens 12 combines the laser light LB transmitted by the beam splitter 5 in the optical fiber 14 to be output.

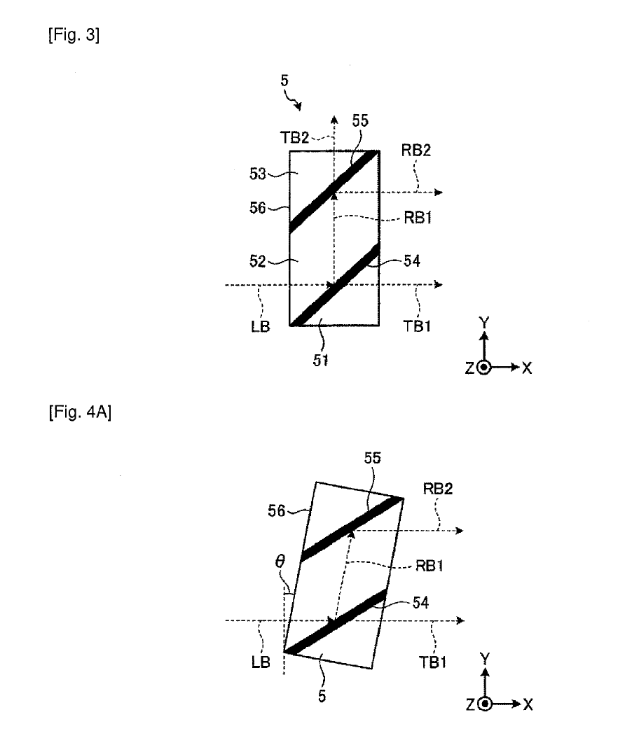

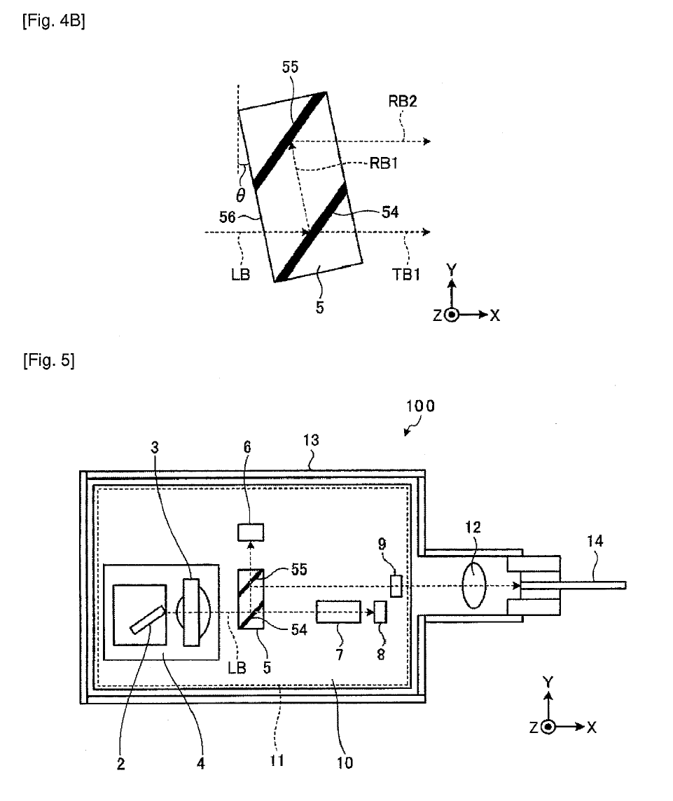

The beam splitter 5 adopts the following structure in order to prevent change of the direction of the optical axis of the split light in an XY-plane parallel to the installation surface of the laser module 1. The following describes the structure of the beam splitter 5 with reference to FIGS. 3, 4A, and 4B.

FIG. 3 is a schematic view of the structure of the beam splitter 5 as seen from above. FIGS. 4A and 4B schematically show change in the optical paths of the split light and transmitted light resulting from a change in the angle of the incident surface of the beam splitter 5 within a plane parallel to the installation surface. As shown in FIG. 3, the beam splitter 5 has a rectangular parallelepiped shape formed by attaching a prism 51, a prism 52, and a prism 53 using a resin adhesive. For example, the beam splitter 5 may have a rectangular parallelepiped shape with dimensions of 1.2 millimeters in the X-axis direction, 27 millimeters in the Y-axis direction, and 1.2 millimeters in the Z-axis direction. The bonding surfaces of the prism 51, the prism 52, and the prism 53 are arranged such that a bonding surface 54 formed between the prism 51 and the prism 52 and a bonding surface 55 formed between the prism 52 and the prism 53 are parallel to each other.

The bonding surface 54 between the prism 51 and the prism 52 functions as the first reflective surface according to the present invention. Specifically, the bonding surface 54 generates a transmitted light TB1 by transmitting a portion of the laser light LB guided by the collimating lens 3 and generates a reflected light RB1 by reflecting the other portion of the laser light LB guided by the collimating lens 3. The transmitted light TB1 is guided to the optical isolator 9.

The bonding surface 55 between the prism 52 and the prism 53 functions as the second reflective surface according to the present invention. Specifically, the bonding surface 55 generates a transmitted light TB2 by transmitting a portion of the reflected light RB1 reflected by the bonding surface 54. The bonding surface 55 also generates a reflected light RB2 by reflecting, in a direction parallel to the laser light LB, the other portion of the reflected light RB1 reflected by the bonding surface 54. The transmitted light TB2 and the reflected light RB2 are respectively guided to the power-monitoring photodiode 6 and the etalon filter 7.

Since the bonding surface 54 and the bonding surface 55 are parallel to each other in the beam splitter 5 having the structure described above, even when an incident surface 56 of the beam splitter 5 is skewed by an angle Theta from the design value in the XY-plane, as shown in FIGS. 4A and 4B, the direction of the optical axis of the reflected light RB2, which is the split light, is always parallel to the direction of the optical axis of the laser light LB guided by the collimating lens 3. Accordingly, even when the angle of the incident surface 56 of the beam splitter 5 changes in the XY-plane with respect to the laser light LB, change in the direction of the optical axis of the reflected light RB2 in the XY-plane can be prevented.

When the incident surface 56 of the beam splitter 5 is skewed by an angle Theta from the design value in the XY-plane, the direction of the optical axis of the reflected light RB2 does not change, but the direction of the optical axis of the transmitted light TB2 does change. Therefore, in the present embodiment, the reflected light RB2 is guided to the toward the etalon filter 7, which has optical characteristics sensitive to change in the angle of incidence of the laser light LB, and the transmitted light TB2 is guided toward the power-monitoring photodiode 6. As a result, the direction by which the beam resulting from the splitting of the laser light LB is incident on the etalon filter 7 is prevented from differing from the direction of the optical axis of the laser light LB. Therefore, the wavelength-monitoring photodiode 8 can accurately detect the wavelength of the laser light LB.

The following describes a method for assembling the laser module 1. When assembling the laser module 1, first, the beam splitter 5 is fixed on the base plate 10 to which the laser light source 2, the collimating lens 3, the Peltier device 4, the power-monitoring photodiode 6, and the wavelength-monitoring photodiode 8 are attached. The beam splitter 5 may be fixed on the base plate 10 using a resin adhesive applied to the surface on which the beam splitter 5 is to be installed.

Next, the power-monitoring photodiode 6 is aligned such that transmitted light TB2 is guaranteed to be incident on the power-monitoring photodiode 6. The etalon filter 7 and the optical isolator 9 are then fixed on the base plate 10. Finally, this base plate 10 is housed in the case 13 including the Peltier device 11 and the focusing lens 12, thereby completing the assembly of the laser module 1.

As made clear from the above description, according to the laser module 1 of the first embodiment of the present invention, the beam splitter 5 includes the bonding surface 54 and the bonding surface 55 that are parallel to each other. The bonding surface 54 transmits a portion of the laser light LB and reflects the other portion of the laser light LB toward the bonding surface 55. The bonding surface 55 reflects the laser light that was reflected by the bonding surface 54. With this structure, the direction of the optical axis of the reflected light RB2 is always parallel to the direction of the optical axis of the laser light LB. Therefore, even when the angle of the incident surface 56 of the beam splitter 5 changes with respect to the laser light LB in the XY-plane, change in the direction of the optical axis of the reflected light RB2 in the XY-plane can be prevented.

### Second Embodiment

FIG. 5 is a cross-sectional schematic view of a laser module 100 according to the second embodiment of the present invention as seen from above. Similarly to the laser module 1, the laser module 100 includes the laser light source 2, the collimating lens 3, the Peltier device 4, the beam splitter 5, the power-monitoring photodiode 6, the etalon filter 7, the wavelength-monitoring photodiode 8, the optical isolator 9, the base plate 10, the Peltier device 11, and the focusing lens 12, and these components are housed in the case 13.

The laser module 1 according to the first embodiment guides the transmitted light TB1 of the beam splitter 5 to the optical isolator 9 and guides the reflected light RB2 of the beam splitter 5 to the etalon filter 7. The laser module 100, on the other hand, guides the transmitted light TB1 of the beam splitter 5 to the etalon filter 7 and guides the reflected light RB2 of the beam splitter 5 to the optical isolator 9.

The direction of the transmitted light TB1 of the beam splitter 5 is the same as the direction of the optical axis of the laser light LB, and therefore the direction of incidence of the transmitted light TB1 with respect to the etalon filter 7 is prevented from differing from the direction of the optical axis of the laser light LB. Accordingly, the wavelength-monitoring photodiode 8 can accurately detect the wavelength of the laser light LB.

The above describes embodiments result from the inventors applying the present invention, but the present invention is not limited by the drawings and description provided above, which describe only embodiments of the present invention as a portion thereof.

In the above embodiments, an array-type semiconductor laser element is used as the laser light source 2, but the laser light source 2 may instead be a longitudinal single-mode semiconductor laser element single formed by a single DFB laser element or DBR (Distributed Bragg Reflector) laser element that does not include a multiplexer 23 or a semiconductor optical amplifier 25. If the beam splitter 5 has a metal base, the beam splitter 5 may be fixed on the base plate 10 using YAG laser welding or soldering. In this way, other embodiments, operating techniques, or the like that can be achieved by someone skilled in the art based on the above embodiments are all included in the scope of the present invention.

### LIST OF REFERENCE NUMERALS

1, 100 laser module

2 laser light source

3 collimating lens

4, 11 Peltier device

12 focusing lens

13 case

14 optical fiber

21 semiconductor laser array

22, 24 waveguide

23 multiplexer

25 semiconductor optical amplifier

26 curved waveguide

27 substrate

51, 52, 53 prism

54, 55 bonding surface

56 incident surface

211 semiconductor laser element

1. A laser module comprising:
a laser light source that emits a laser light; and
a beam splitter that splits a portion of the laser light emitted from the laser light source, wherein
the beam splitter includes a first reflective surface and a second reflective surface parallel to each other,
the first reflective surface transmits a first portion of the laser light and reflects a second portion of the laser light to the second reflective surface, and
the second reflective surface receives the second portion of the laser light from the first reflective surface and reflects received laser light in a direction parallel to the laser light emitted from the laser light source.

2. The laser module according to claim 1, wherein the second reflective surface transmits a first portion of the received laser light and reflects a second portion of the received laser light in the direction parallel to the laser light emitted from the laser light source.

3. The laser module according to claim 1, further comprising a wavelength detector that receives the first portion of the laser light transmitted by the first reflective surface or the second portion of the received laser light reflected by the second reflective surface, and detects a wavelength of the laser light emitted from the laser light source.

4. The laser module according to claim 3, wherein the wavelength detector includes an etalon filter that selectively transmits a laser light of a predetermined wavelength.

5. The laser module according to claim 1, wherein the beam splitter has a rectangular parallelepiped shape formed by bonding a plurality of prisms, and the resulting bonding surfaces between the prisms function respectively as the first reflective surface and the second reflective surface.

6. The laser module according to claim 5, wherein the prisms are bonded using a resin adhesive.

7. The laser module according to claim 1, wherein the laser light source is a distributed feedback semiconductor laser element.

8. The laser module according to claim 1, wherein the laser light source is a distributed Bragg reflector semiconductor laser element.

9. The laser module according to claim 1, wherein the laser light source is an array-type semiconductor laser element obtained by integrating a plurality of longitudinal single-mode semiconductor laser elements, a semiconductor optical amplifier that amplifies a laser light emitted from at least one of the longitudinal single-mode semiconductor laser elements, and a multiplexer that guides the laser light emitted from the at least one of the longitudinal single-mode semiconductor laser elements to the semiconductor optical amplifier.
